(19) United States
(12) Patent Application Publication
(10) Pub. No.: US 2010/0065642 A1
(43) Pub. Date: Mar. 18, 2010

(54) BAR CODE READER

(75) Inventor: Hyun Woo An, Seoul (KR)

Correspondence Address: CANTOR COLBURN, LLP, 20 Church Street, 22nd Floor, Hartford, CT, 06103, US

(73) Assignee: BLUEBIRD SOFT CO., LTD., Seoul (KR)

(21) Appl. No.: 12/519,637

(22) PCT Filed: Dec. 17, 2007
(86) PCT No.: PCT/KR2007/006601

§ 371 Date: Jun. 17, 2009

(30) Foreign Application Priority Data
Dec. 18, 2006 (KR) 10-2006-0129090

(51) Int. Cl. G06K 7/10

(52) U.S. Cl. 235/462.43

(57) ABSTRACT

A bar code reader includes a casing having an inner space for accommodating a plurality of internal components, and a bar code reader module disposed within the inner space of the casing for reading a bar code of a target object through a projection window provided to one side of the casing. A speaker module is disposed adjacently to the bar code reader module for generating the reading by the bar code reader module as a signal sound to send it to a speaker hole formed in the casing, and a module bracket integrally supports the bar code reader module and the speaker module for integrally assembling the bar code reader module and the speaker module to corresponding places within the casing. The bar code reader module and the speaker module are integrally supported using a single item to decrease the number of components and overall cost. Also, assembling can be simplified to reduce a loss conventionally caused by the increase of the components.

### TECHNICAL FIELD

The present invention is directed to a bar code reader, and more particularly, to a bar code reader having a bar code reader module and a speaker module integrally supportable by a single unit to reduce the number of components and decrease overall cost, and of which assembling is simplified to decrease a loss typically caused by an increase of the number of components.

### BACKGROUND ART

Codes generally designate English characters, numerals or special symbols for recognizing predetermined objects. However, it is a troublesome and difficult job when memorizing every code one by one and sending it into a computer. In particular, separate code managing of diverse kinds of items such as daily commodities is next to impossible.

In order to solve these problems, bar codes was developed by combining variously thick bars as codes instead of ordinary codes, and an apparatus of optically reading and sending the bar codes into a computer is referred to as a bar code reader.

In other words, a bar code reading machine named as the bar code reader is one kind of an input device that reads out an electronic signal produced by an intensity of reflected light after emitting an electron beam onto a printed bar code.

The bar code reader uses an optical theory that an electronic signal is generated according to an intensity of light reflected after emitting the light onto an input medium printed with a bar code thereon, and then a logic circuit is operated by the electronic signal to convert it to an inner code of a computer.

Actually, it is commonly taken place that the bar code printed on an item is read using the bar code reader when a customer purchases commodities in a store such as a supermarket to thereby immediately make sales data. Because of advantages of an accurate data input and a convenient use, the bar code is being widely available from the production management to the sales management of commodities, and especially is regarded as an evolution in a distribution field. Accordingly, the bar code reader is further frequently used in recent years.

Meantime, a typical bar code reader includes a bar code reader module for substantially reading the bar code, and a speaker module for producing a predetermined signal sound of reading (referred to as “scanning” performed by the bar code reader module. Thus, when a user reads the bar code through the bar code reader module by manipulating a switch, a signal sound suitable for the reading is generated through the speaker module.

However, in the conventional bar code reader, support units such as a bracket that supports the bar code reader module or the speaker module are separately furnished to independently support each bar code reader module and the speaker module. Therefore, there are problems of increasing cost resulting from an increase of the number of components and causing diverse losses such as complicating the assembling thereof.

### DISCLOSURE OF INVENTION

### Technical Problem

The present invention provides a bar code reader having a bar code reader module and a speaker module integrally supported using a single unit to decrease the number of components and overall cost, of which assembling is simplified to thus reduce a loss conventionally caused due to an increase of the number of components.

### Advantageous Effects

According to the bar code reader of the present invention, a bar code reader module and a speaker module can be integrally supported as a single unit to decrease the number of components and overall cost. Also, assembling can be simplified to reduce the loss resulting from conventional increase of the number of components, thereby decreasing the loss caused by the increase of the assembling.

### DESCRIPTION OF DRAWINGS

FIG. 1 is an image of a bar code reader according to an embodiment of the present invention.

FIG. 2 is a perspective view illustrating the image of FIG. 1 at another angle.

FIG. 3 is a side view briefly projecting an inside of FIG. 2 for illustrating internal components.

FIG. 4 is a perspective view illustrating a module bracket region.

FIG. 5 is a frontal perspective view illustrating the module bracket of FIG. 4.

FIG. 6 is a rear-side perspective view illustrating the module bracket of FIG. 5.

FIG. 7 is an exploded perspective view illustrating a coupling structure of a projection window protecting rim and a casing.

FIG. 8 is an exploded perspective view illustrating a coupling structure of the casing and a battery cover.

FIG. 9 is a rear side view illustrating a top cover and a perspective view illustrating a light guide plate coupled to the top cover.

### BEST MODE

According to an embodiment of the present invention, there is provided a bar code reader including: a casing having an inner space for accommodating a plurality of internal components; and a bar code reader module disposed within the inner space of the casing for reading a bar code of a target object through a projection window provided to one side of the casing. Also provided are a speaker module disposed adjacently to the bar code reader module for generating the reading by the bar code reader module as a signal sound to send it to a speaker hole formed in the casing; and a module bracket integrally supporting the bar code reader module and the speaker module for integrally assembling the bar code reader module and the speaker module to corresponding places within the casing.

At this time, the module bracket includes: a first bracket portion for supporting by partially encompassing the bar code reader; a second bracket portion extending from one side of the first bracket portion for supporting by partially encompassing the speaker module; and a coupling portion disposed to either one of the first and second bracket portions, and forming a coupling path of a coupling member for coupling the module bracket to the casing.

The module bracket is joined to a main Printed Circuit Board (PCB) disposed where the bar code reader module is disposed; and the first bracket portion includes at least one hook for temporarily supporting the module bracket to the main PCB.

The first bracket portion is shaped as a rectangular box having at least one side open; and the coupling portion is each formed to both sides of the first bracket portion. The casing and openings formed by the first and second bracket portions are each disposed toward the projection window and the speaker hole when the module bracket is assembled within the casing.

At this time, the first and second bracket portions and the coupling portion is formed of a synthetic resin integrally injection molding.

Furthermore, the bar code reader includes an input button coupled by being partially exposed from a hand-held unit formed to one side of the casing for supplying a reading operation signal; an auxiliary Printed Circuit Board (PCB) disposed within the casing having the input button, and having a tact switch for generating pressing of the input button as an electrical signal; and a connecting unit flexibly and electrically connecting the main PCB to the auxiliary PCB.

Here, the connecting part is Flexible Printed Circuit Board (FPCB).

Additionally, the bar code reader, further includes: a top cover coupled to an upper surface of the casing to be assembled and dissembled, wherein the top cover is coupled with a power switch; and a display unit is disposed around the power switch for sending whether the reading is performed or not by pressing the input button by an on/off flickering signal.

The display unit includes: a first display window formed to the casing along a circumferential surface of the power switch; a second display window formed to the casing, and separated from the first display window; at least one Light Emitting Diode (LED) coupled to the main PCB for forming a light emitting power source; a light guide plate for integrally connecting the first and second display windows to sent the light formed by the LED to both first and second display windows areas; and a control unit for selectively controlling an on/off control of the LED based on whether the input button is operated or not.

The control unit controls to turn on the LED by pressing the input button when the reading is performed, and turn off the LED by releasing the pressing of the input button when the reading is stopped.

The casing includes front and rear side casings, which can be mutually assembled and dissembled; and a projection window protecting rim coupled to the projection window region when the front and rear side casings are assembled to each other.

Moreover, the projection window protecting rim is formed of an elastic substance retaining a buffering force.

A plurality of catch hooks are formed to either one of the projection window protecting rim and an edge of the casing coupled with the projection window protecting rim, and hook holes caught by the plurality of catch hooks are formed to the other end of the casing.

A battery cover that can be dissembled and assembled for inhibiting separation of a battery disposed within the casing.

### MODE FOR INVENTION

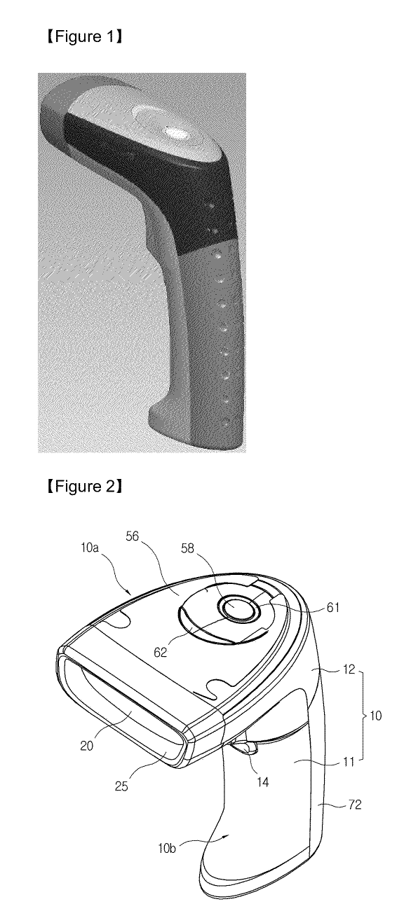

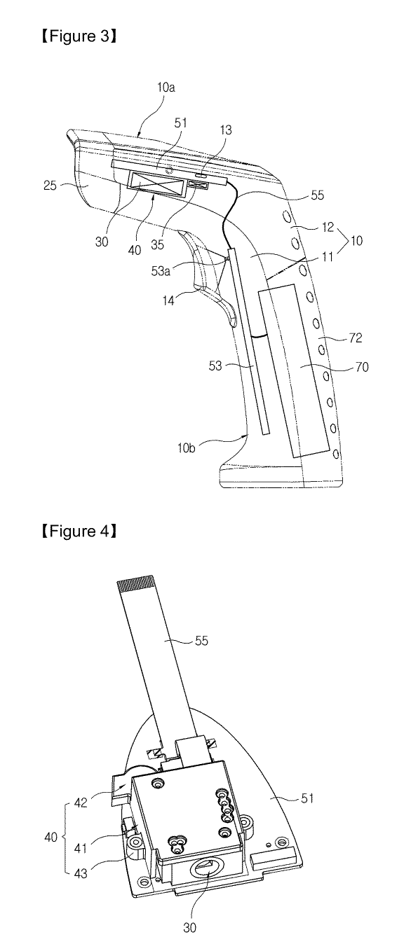

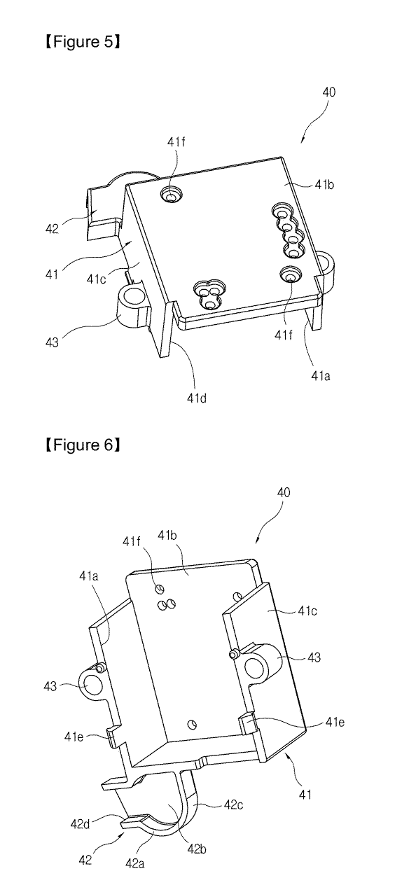

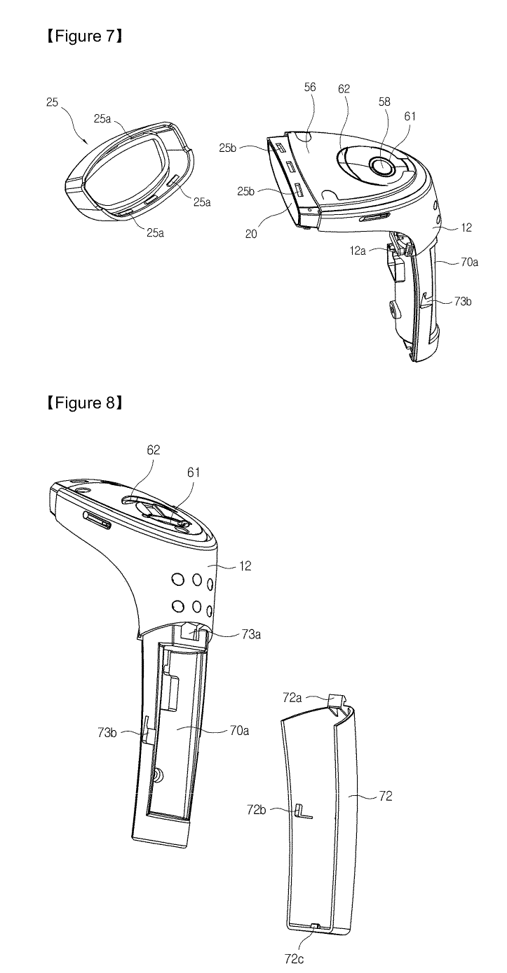

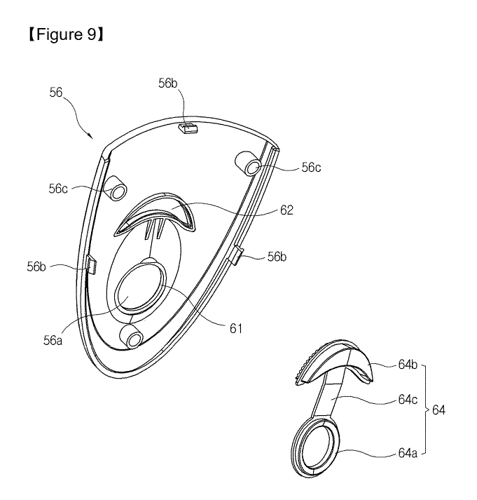

Embodiments of the present invention are described in detail in the detailed description and the accompanying drawings. The advantages and features of the present invention and a method of realizing the present invention will be clarified with reference to embodiments which will now be described more fully with reference to the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. The present invention is defined by definitions recited in the claims only. In the specification, like reference numerals in the drawings denote like elements. FIG. 1 is an image of a bar code reader according to an embodiment of the present invention. FIG. 2 is a perspective view illustrating the image of FIG. 1 at another angle. FIG. 3 is a side view briefly projecting an inside of FIG. 2 for illustrating internal components. FIG. 4 is a perspective view illustrating a module bracket region. FIG. 5 is a frontal perspective view illustrating the module bracket of FIG. 4. FIG. 6 is a rear-side perspective view illustrating the module bracket of FIG. 5. FIG. 7 is an exploded perspective view illustrating a coupling structure of a projection window protecting rim and a casing. FIG. 8 is an exploded perspective view illustrating a coupling structure of the casing and a battery cover. FIG. 9 is a rear side view illustrating a top cover and a perspective view illustrating a light guide plate coupled to the top cover.

As illustrated in the drawings, the bar code reader according to an embodiment of the present invention includes a casing 10 having a space for accommodating a plurality of inner components (not shown) therein, and a bar code reader module 30 (refer to FIGS. 3 and 4) for reading (scanning) a bar code of a target object through a projection window 20 provided to one side of the casing 10. Additionally, a speaker module 35 (refer to FIG. 3) disposed adjacently to the bar code reader module 30 makes the reading by the bar code reader module 30 be generated as a signal sound to send it to a speaker hole 13 formed in the casing 10. Also provided is a module bracket 40 integrally supporting the bar code reader module 30 and the speaker module 35 so as to make the bar code reader module 30 and the speaker module 35 be integrally assembled to corresponding places within the casing 10.

The casing 10 forms an outer appearance of the bar code reader according to this embodiment of the present invention. In order to install or maintain various internal components, the casing 10 includes a front side casing 11 and a rear side casing 12, which can be mutually assembled and dissembled from each other.

A hook-like coupling structure is embodied to the front and rear side casings 11 and 12 so as to facilitate the mutual assembling and dissembling of the front and rear side casings 11 and 12. For example, if a hook (not shown) is provided to the front side casing 11, the hook provide to the front side casing 11 and a hook catch part 12a provided to the rear side casing 12 correspond to each other, and the front and rear side casings 11 and 12 are mutually pressed and closely attached to thereby assemble the bar code reader as a completely produced item as illustrated in FIG. 1. Of course, if the coupling force is weak solely by the hook-like coupling structure, a bolt setting may be added. Actually, the bolt setting is added to the rear surface of the rear side casing 12 to join the rear side casing 12 to the front side casing 11, thereby increasing the joining force of the front and the rear side casings 11 and 12.

The casing 10 is formed by two bodies of the front and rear side casings 11 and 12, but, hereinafter, will be classified into two portions for convenience of description. That is, the casing 10 will be classified into a head unit 10a having the bar code reader module 30, the speaker module 35 and a main Printed Circuit Board (PCB) 51 that will be described later, and a hand-held unit 10b longitudinally extending from the head unit 10a for holding the bar code reader by a user.

The projection window 20 is provided to a front surface of the head unit 10a. The light generated from the bar code reader module 30 through the projection window 20 reaches the bar code of the target object, and then information of the bar code is read out by reading an electronic signal generated in accordance with the intensity of reflected light.

Therefore, it is preferable that the projection window 20 is formed of a transparent glass or a plastic substance pertinent to the glass that at least allows for transmission of light. However, since the scope of the present invention is not limited thereto, there is no need to necessarily form the projection window 20 using the transparent substance, and a semi-transparent substance may be used. When required, the projection window 20 may be tinted with a certain color.

When the front and rear side casings 11 and 12 are mutually coupled to each other, an outer periphery of the projection window 20 may be received into a groove (not shown) formed in one sides of the front and rear side casings 11 and 12.

A projection window protecting rim 25 is added to the front surface of the head unit 10a having the projection window 20. The rectangular hook-shaped projection window protecting rim 25 is coupled to the front area of the head unit 10a when the single casing 10 is formed by mutually assembling the first and rear side casings 11 and 12, thereby protecting the projection window 20 and impeding the mutually assembled front and rear side casings 11 and 12 from being arbitrarily dissembled from each other. Accordingly, the projection window protecting rim 25 may be formed of at least an elastic substance retaining a buffering force. Rubber or silicon may be applied as the elastic substance.

Further to multiplying the joining force of the front and rear side casings 11 and 12 at the corresponding place, the projection window protecting rim 25 may add a water-proof function at this place. Therefore, in order to secure the stronger water-proof function, the projection window protecting rim 25 may be firmly and forcefully coupled to the corresponding place.

Referring to FIG. 7, a plurality of hooks 25a are provided along the inner surface of the projection window protecting rim 25. Also, hook holes 25b for being caught by the hooks 25a are formed in the edge surface of the casing 10 to correspond to the plurality of hooks 25a. By doing so, when the projection window protecting rim 25 is coupled to the edge surface of the casing 10, the plurality of hooks 25a are caught by the hook holes 25b, so that the projection window protecting rim 25 can be firmly fixed at the corresponding place.

The bar code reader module 30 is provided within the head unit 10a (refer to FIG. 3). As described above, the bar code reader module 30 acts for emitting the light through the projection window 20 to make it reach the bar code of the target object, and reading the information of the bar code by reading out the electronic signal generated in conformity with the intensity of the reflected light. Accordingly, even not be illustrated, the bar code reader module 30 may be united with a laser diode, a collimator lens, a light emitting diode, a camera lens, a pattern lens, an image sensor, etc.

The speaker module 35 produces a success of the reading by the bar code reader module 30 as a signal sound while performing the reading. The signal sound produced at this time may be externally supplied via the speaker hole 13 formed in the side of the head unit 10a. Thus, the user can aurally confirm whether the reading is normally performed or not.

On the other hand, since both the bar code reader module 30 and the speaker module 35 are components used for the reading of the bar code, they have to be assembled to the corresponding places within the casing 10. However, the conventional manner of complicated assembling the bar code reader module 30 and the speaker module 35, or individually using a bracket (not shown) for assembling the bar code reader module 30 and the speaker module 35 may cause several losses such as increasing of overall cost and complicating the assembling.

Due to these problems, in this embodiment of the present invention as described below, a module bracket 40 as a single component is used for integrally supporting the bar code reader module 30 and the speaker module 35, so that the bar code reader module 30 and the speaker module 35 can be integrally assembled at the corresponding places within the casing 10.

In this embodiment, the bar code reader module 30 and the speaker module 35 are coupled to the main PCB 51 disposed to a rear surface of the rear side casing 12 within the head unit 10a. However, the scope of the present invention is not limited thereto, and therefore, the module bracket 40 may be united to the front side casing 11 side within the head unit 10.

Referring to FIGS. 3 through 6, the module bracket 40 includes a first bracket portion 41 partially encompassing to support the bar code reader module 30, a second bracket portion 42 extending from one side of the first bracket portion 41 for partially encompassing to support the speaker module 35, and a coupling portion 43 disposed to the first bracket portion 41. Such the module bracket 40 is formed of a synthetic resin by injection molding at one body. However, the scope of the present invention is not limited thereto, and, thus, the module bracket 40 may be formed of a metal substance.

The first bracket portion 41 is shaped as a rectangular box with at least one side open. That is, a front side 41a is open, and a rear side 41b and three sidewall surfaces 41c are provided to construct the approximate rectangular box shape. By this structure, the bar code reader module 30 is supported and housed within the first bracket portion 41. At this time, an opening 41d provided to the sidewall of the first bracket portion 41 is disposed to face the projection window 20. A plurality of coupling holes 41f are formed in the rear surface 41b of the first bracket portion 41 for coupling to the bar code reader module 30.

The first bracket portion 41 further includes a plurality of hooks 41e temporarily supporting the module bracket 40 to the main PCB 51 when the module bracket 40 is coupled to the main PCB 51. Accordingly, under the state that the plurality of hooks 41e are temporarily inserted to support hook holes (not shown) formed in the main PCB 51, the module bracket 40 is fixed using coupling members (not shown) to be described later.

The second bracket portion 42 extends to one side of the first bracket portion 41 while forming an independent space with the first bracket portion 41. Similarly to the first bracket portion 41, a front side 42a of the second bracket portion 42 is open, and the speaker module 35 is partially supported by being encompassed by a rear surface 42b and a sidewall surface 42c. At this time, an opening 42d constituting an exposed end of the second bracket portion 42 is provided to face the speaker hole 13 formed in the head unit 10a.

The coupling portion 43 is used as a coupling path in which the coupling member (not shown) is inserted to couple the module bracket 40 to the casing 10. Therefore, the coupling portion 43 may be provided to either one of the first and second bracket portions 41 and 42, but, in this embodiment, the coupling portion 43 is each formed in both sides of the first bracket portion 41. A bolt and so on may be used as a coupling member.

Meanwhile, as described above, the main PCB 51 is provided where the bar code reader module 30 is disposed. The main PCB 51 controls the overall operation with respect to the bar code reader of this embodiment according to the present invention.

An auxiliary PCB 53 is further provided within the casing 10 in addition to the main PCB 51. The auxiliary PCB 53 is disposed within the casing 10 where an input button 14 exposed outward from the front surface of the hand-held unit 10b. A tact switch 53a for generating the pressing of the input button 14 as an electrical signal is provided to the auxiliary PCB 53. The main and auxiliary PCB 51 and 53 are commonly and electrically connected to each other, using a connecting unit 55. In this embodiment, a Flexible Printed Circuit Board (FPCB) is used as the connecting unit 55.

Then, when the user presses the input button 14 while gripping the hand-held unit 10b, the tact switch 53a is operated by the pressing of the input button 14. Then, such a signal is supplied to the main PCB 51 through the connecting unit 55, thereby performing the reading using the bar code reader module 30.

On the other hand, a top cover 56 (refer to FIG. 9) is attachable to and detachable from the upper surface of the head unit 10a. Also, a power switch 58 is joined to the top cover 56. The power switch 58 is used for supplying or blocking an electric power to the bar code reader.

In order to couple the power switch 58, a switch hole 56a is formed in the plate surface of the top cover 56. Also, a plurality of hooks 56b to be caught to the upper surface of the head unit 10a, and a screw set boss 56c are provided to an a periphery of the top cover 56.

Around the power switch 58, a display unit 60 is further added for sending progressing of the above-described reading by the pressing of the input button 14 as an On/Off flickering signal of a lamp.

The display unit 60 includes a first display window 61 formed to the casing 10 along a circumferential surface of the power switch 58, and a second display window 62 disposed to the casing 10 separated from the first display window 61. Furthermore, a plurality of LEDs (not shown) coupled to the main PCB 51 to form a light emitting source, and a light guide plate 64 mutually and integrally connecting the first and second display units 61 and 62 within the casing 10 sends the light formed by the LED to both the first and second display windows 61 and 62 regions within the casing 10. Additionally, the display unit 60 includes a control unit (not shown) that selectively controls the on/off of the LED based on whether the input button 14 is operated or not.

The first display window 61 is approximately doughnut-shaped because of being formed along the circumferential surface of the power switch 58. Whereas, the second display window 62 forms approximately a half moon shape on a place separated from the first display window 62. However, the shapes of the first and second display windows 61 and 62 are just one embodiment, which thus may not be the same as illustrated in the drawing.

The light guide plate 64 includes a doughnut portion 64a disposed to the first display window 61, a half-moon portion 64b disposed to the second display window 62, and a connecting bar 64c for connecting the doughnut portion 64a and the half moon portion 64b. Accordingly, when the light emitted from the LED reaches the light guide plate 64, the light spreads over the whole area of the doughnut portion 64a, the connection bar 64c and the half moon portion 64b, which form the light guide plate 64 to thus form the light in the first and second display windows 61 and 62.

The control unit controls to turn on the LED when the input button 14 is pressed to perform the reading, and turn off the LED when the reading is stopped by releasing the pressing of the input button 14. Accordingly, when the user presses the input button 14 to perform the reading, the first and second display windows 61 and 62 emit the light. Also, when the pressed input button 14 is released, the light emitted from both the first and second display windows 61 and 62 is extinguished. Therefore, it is advantageous of easily discriminating whether the reading is performed or not by the display unit 60 together with the foregoing speaker module 35.

Meanwhile, in the bar code reader according to this embodiment of the present invention, a battery 70 for supplying an electric power to the above-described main PCB 51 is provided within a battery holder 70a. As a reference, a battery cover 72 may be disposed to the front side casing 11, but is formed to the rear side casing 12 in this embodiment for convenience of use.

In order to exchange the battery 70, the battery cover 72 may be assembled to and dissembled from the rear side casing 12. For this operation, referring to FIG. 8, the battery cover 72 has a first hook 72a provided to an upper portion thereof, a pair of second hooks 72b disposed to both sides thereof, and a third hook 72c disposed to a bottom surface thereof.

Also, corresponding to such a structure, the rear side casing 12 has a first hook hole 73a corresponding to the first hook 72a, second hook holes 73b corresponding to the pair of second hooks 72b, and a third hook hole (not shown) corresponding to the third hook 72c.

Thus, the user can join the battery cover 72 to the rear side casing 12 by upward pushing the battery cover 72 in a direction of inserting the pair of second hooks 72b into the second hook holes 73b, and the first hook 72a into the first hook hole 73b under a state that the third hook 72c of the battery cover 72 is disposed into the third hook hole (not shown).

By this construction, the bar code reader module 30 and the speaker module 35 are supported at one time using the module bracket 40 that is a single member to be coupled to the main PCB 51, and then the front and rear side casings 11 and 12 are coupled to each other. Thereafter, the projection window protecting rim 25 is coupled to the front side of the casing 10.

When the bar code reader is intended to be used under this state, the power switch 58 is on while gripping the hand-held unit 10b. Then, the projection window 20 is disposed adjacently to the bar code to be read. Under this state, the input button 14 disposed on the front side of the hand-held unit 10b is pressed.

By doing so, the tact switch 53a is operated by the pressing of the input button 14, and such a signal is sent to the main PCB 51 through the connecting unit 55 to thereby perform the reading by the bar code reader module 30. That is, the light is emitted from the bar code reader module 30 through the projection window 20 to reach the bar code of the target object, and the electronic signal generated according to the intensity of the reflected light is read out to read the information of the bar code.

If the above-described operation is normally performed, the reading is perceived by the signal sound from the speaker module 35, and the signal sound is externally supplied through the speaker hole 13 formed in the casing 10.

According to this embodiment of the present invention as described above, the bar code reader module 30 and the speaker module 35 are integrally supportable by the single member to decrease the number of components while reducing the overall cost. Furthermore, the assembling can be simplified to decrease the loss conventionally caused due to the increase of the number of components.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, a bar code reader module and a speaker module are integrally supportable by a single member to decrease the number of components while reducing overall cost. Furthermore, assembling can be simplified to decrease a loss conventionally caused due to an increase of the number of components.

What is claimed:

1. A bar code reader comprising:
a casing having an inner space for accommodating a plurality of internal components;
a bar code reader module disposed within the inner space of the casing for reading a bar code of a target object through a projection window provided to one side of the casing;
a speaker module disposed adjacently to the bar code reader module for generating the reading by the bar code reader module as a signal sound to send it to a speaker hole formed in the casing; and
a module bracket integrally supporting the bar code reader module and the speaker module for integrally assembling the bar code reader module and the speaker module to corresponding places within the casing.

2. The bar code reader of claim 1, wherein the module bracket comprises:
a first bracket portion for supporting by partially encompassing the bar code reader;
a second bracket portion extending from one side of the first bracket portion for supporting by partially encompassing the speaker module; and
a coupling portion disposed to either one of the first and second bracket portions, and forming a coupling path of a coupling member for coupling the module bracket to the casing.

3. The bar code reader of claim 2, wherein the module bracket is joined to a main Printed Circuit Board (PCB) disposed where the bar code reader module is disposed; and
the first bracket portion comprises at least one hook for temporarily supporting the module bracket to the main PCB.

4. The bar code reader of claim 2, wherein the first bracket portion is shaped as a rectangular box having at least one side open; and
the coupling portion is each formed to both sides of the first bracket portion.

5. The bar code reader of claim 2, wherein the casing and openings formed by the first and second bracket portions are each disposed toward the projection window and the speaker hole when the module bracket is assembled within the casing.

6. The bar code reader of claim 2, wherein the first and second bracket portions and the coupling portion is formed of a synthetic resin integrally injection molding.

7. The bar code reader of claim 3, comprising;
an input button coupled by being partially exposed from a hand-held unit formed to one side of the casing for supplying a reading operation signal;
an auxiliary Printed Circuit Board (PCB) disposed within the casing having the input button, and having a tact switch for generating pressing of the input button as an electrical signal; and
a connecting unit flexibly and electrically connecting the main PCB to the auxiliary PCB.

8. The bar code reader of claim 7, wherein the connecting part is a Flexible Printed Circuit Board (FPCB).

9. The bar code reader of claim 7, further comprising:
a top cover coupled to an upper surface of the casing to be assembled and dissembled, wherein the top cover is coupled with a power switch; and
a display unit is disposed around the power switch for sending whether the reading is performed or not by pressing the input button by an on/off flickering signal.

10. The bar code reader of claim 9, wherein the display unit comprises:
a first display window formed to the casing along a circumferential surface of the power switch;
a second display window formed to the casing, and separated from the first display window;
at least one Light Emitting Diode (LED) coupled to the main PCB for forming a light emitting power source;
a light guide plate for integrally connecting the first and second display windows to sent the light formed by the LED to both first and second display windows areas; and
a control unit for selectively controlling an on/off control of the LED based on whether the input button is operated or not.

11. The bar code reader of claim 10, wherein the control unit controls to turn on the LED by pressing the input button when the reading is performed, and turn off the LED by releasing the pressing of the input button when the reading is stopped.

12. The bar code reader of claim 6, wherein the casing comprises front and rear side casings, which can be mutually assembled and dissembled; and
a projection window protecting rim coupled to the projection window region when the front and rear side casings are assembled to each other.

13. The bar code reader of claim 12, wherein the projection window protecting rim is formed of an elastic substance retaining a buffering force.

14. The bar code reader of claim 13, wherein a plurality of catch hooks are formed to either one of the projection window protecting rim and an edge of the casing coupled with the projection window protecting rim, and hook holes caught by the plurality of catch hooks are formed to the other end of the casing.

15. The bar code reader of claim 1, further comprising a battery cover that can be dissembled and assembled for inhibiting separation of a battery disposed within the casing.
